(19) United States
(12) Patent Application Publication
(10) Pub. No.: US 2011/0277855 A1
(43) Pub. Date: Nov. 17, 2011

(54) ANTI-SCALDING DEVICE WITH A SPEEDY VENTING EFFECT

(76) Inventor: Senyi Li, Fujian (CN)

(21) Appl. No.: 12/873,865

(22) Filed: Sep. 1, 2010

(30) Foreign Application Priority Data
May 13, 2010 (CN) CN201020193783.7

(51) Int. Cl. F16K 17/38

(52) U.S. Cl. 137/468

(57) ABSTRACT

An anti-scalding device with a speedy venting effect comprises a main body, a sensor, and a housing. A first cavity and a second cavity intercommunicated are formed in the main body. The first cavity communicates with an inlet channel, and a first necking portion with a water hole is formed at a bottom of the first cavity. The second cavity communicates with an outlet. At least one venting hole is defined on pipe walls of the first cavity and the second cavity, respectively. The sensor is arranged in the first cavity of the main body, correspondently located above the venting hole. The housing is densely sealed on the main body but movable thereon. Axially moving or rotating the housing to the main body allows the water with a high temperature obstructed in the channel to be swiftly discharged. Thereby, the sensor timely senses the water with a regular temperature to dredge the channel of the outlet. That is, the operating time of the sensor is shortened, and it is convenient for users.

### BACKGROUND OF THE INVENTION

1. Field of the Invention

The present invention relates to a shower device, in particularly to an anti-scalding device with a speedy venting effect applied to the shower device.

2. Description of the Related Art

During shower, users are easily scaled in view of the unstable water pressure between the cold water and the hot water or due to the improper adjustment in the mixed water that both result in an over-heating water temperature. In order to prevent such a dangerous situation, manufacturers install an anti-scalding device on a channel of an outlet. Generally, the anti-scalding device utilizes a heat-sensing member to sense the variation of the water temperature. While the water temperature is over a predetermined temperature set in the heat-sensing member, an element contained in the heat-sensing member, the chemical wax, accordingly expands in view of the heat. Thereby, the expanding chemical wax pushes a propping shaft to block the outlet and impede the outlet channel. Thence, users are prevented from scalding. After that, the heat-sensing member shrinks for dredging the channel while a descending water temperature is sensed, so that the using safety is assured. However, in the practice, while the water temperature returns to the regular temperature, the heating water is still remained in the channel by the anti-scalding device. As a result, the heat-sensing member is unable to timely sense the succeeding lowered water temperature, and the channel cannot be dredged in a short time. Therefore, users need to wait a long time for the water with a normal temperature, which is quite inconvenient. Especially, if the waiting is happened in the winter time, users may easily get a cold. Thus, the present invention is to amend the existing problem.

### SUMMARY OF THE INVENTION

The object of the present invention is to provide an anti-scalding device with a speedy venting effect for preventing users from being scaled and for a sensor to timely sense the lowered water temperature, so that a channel is dredged and the using convenience is promoted.

An anti-scalding device in accordance with the present invention essentially comprises a main body, a sensor, and a housing. The main body defines a first cavity and a second cavity communicated with each other. The first cavity links with an inlet channel. A first necking portion with a water hole is formed at a bottom of the first cavity. The second cavity links with an outlet. At least one venting hole is arranged on a pipe wall of the first cavity and the second cavity, respectively. The sensor is disposed in the first cavity of the main body corresponding to a top portion of the water hole. The housing is densely sealed for operatively covering on the main body. Moving the housing allows the venting channels between the venting holes to be dredged.

A depressed portion with a larger internal diameter is formed in the middle of the housing. Two ends of the housing respectively form second necking portions with a smaller internal diameter. A resuming spring is disposed between the housing and the main body. Axially moving the housing relative to the main body controls an open-close state of the venting channel between the venting holes.

The main body is composed of a chief body that engages with a connecting portion. A first accommodation is arranged within the chief body for communicating with the inlet channel. A first necking portion with a water hole is formed at the bottom of the first accommodation. At least one venting hole is defined on a side wall of the first accommodation. The second accommodation communicated with the outlet is arranged within the connecting portion. At least two venting holes are defined on a side wall of the second accommodation. Connecting the chief body with the connecting portion allows the venting hole of the first accommodation of the chief body to be disposed in accordance with one of the venting holes of the connecting portion.

A casing pipe rotatively and densely disposed on the main body is engaged with the housing. A torsion spring is installed between the casing pipe and the main body. Openings, whose amount is arranged in accordance with a number of the venting holes of the connecting portion, are defined on the casing pipe. A water cavity is correspondingly formed between the housing of the opening and the casing pipe. A rotation of the housing and the casing pipe corresponding to the main body controls an open-close state of the venting channel between the venting holes.

By means of the venting holes being disposed on the main body, the axial movement or the rotation of the housing to the main body allows the blocked water with a high temperature in the channel to be speedily discharged. Thereby, the sensor is able to timely sense the water with a normal temperature so as to dredge the channel of the outlet. As a result, the operating time of the sensor is shortened, which conduces to a convenient utilization for users.

### BRIEF DESCRIPTION OF THE DRAWINGS

FIG. 1 is an exploded view of the present invention;

FIG. 2 is a schematic view showing the assembled present invention with a regular outlet operation;

FIG. 3 is a schematic view showing the sensor blocking the channel for preventing users from scalding;

FIG. 4 is a schematic view showing the housing being moved for dredging;

FIG. 5 is a schematic view showing the cooperation between the housing and the sensor to dredge the channel;

FIG. 6 is an exploded view showing a second embodiment of the present invention;

FIG. 7 is a cross-sectional view showing the assembled second embodiment of the present invention with a regular outlet operation;

FIG. 8 is a schematic view showing the sensor blocking the channel for preventing users from scalding;

FIG. 9 is a schematic view showing the housing being moved for dredging; and

FIG. 10 is a schematic view showing the cooperation between the housing and the sensor to dredge the channel.

### DETAILED DESCRIPTION OF THE PREFERRED EMBODIMENTS

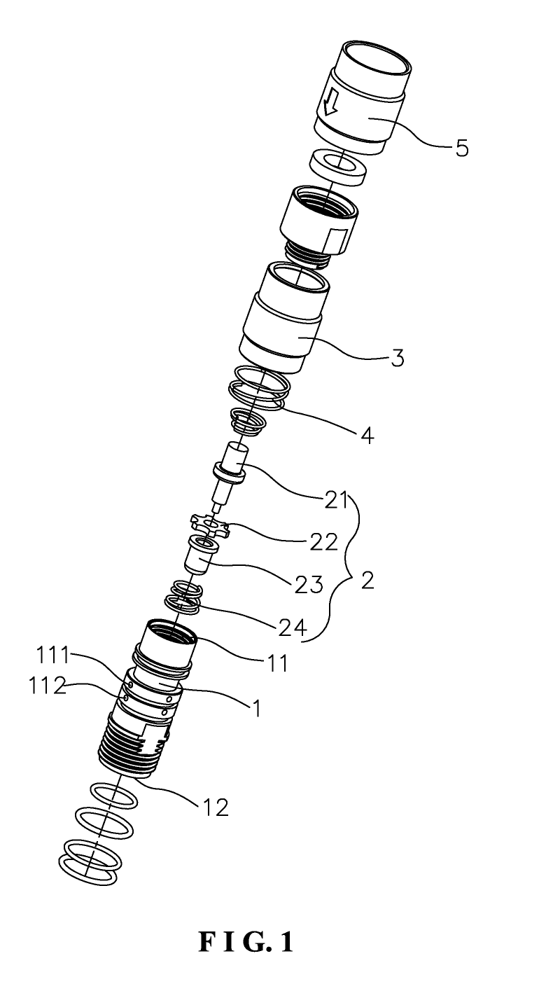

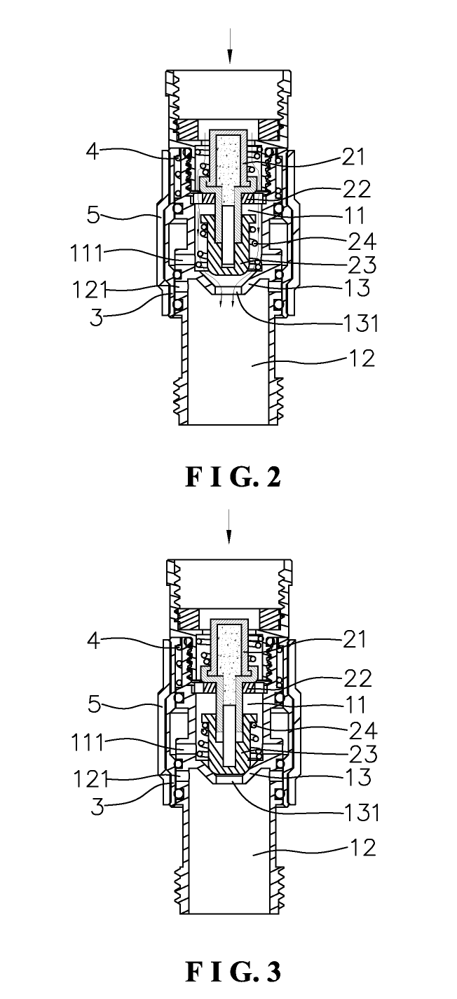

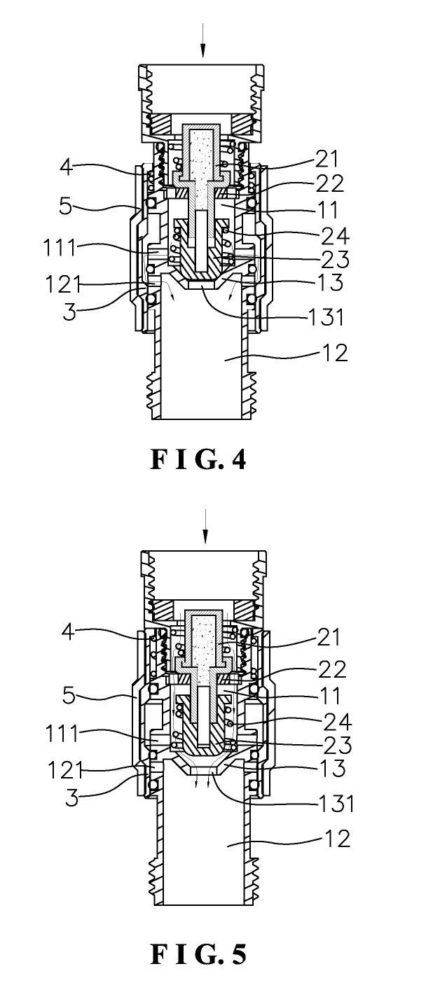

Referring to FIGS. 1 to 5, an anti-scalding device with a speedy venting effect is disposed on a channel of an outlet. The present invention substantially comprises a main body 1, a sensor 2, and a housing 3. The main body 1 adopts a hollow pipe where a first cavity 11 and a second cavity 12 are upward and downward separated and communicated with each other. A first necking portion 13 with a water hole 131 is formed at a bottom of the first cavity 11. The first cavity 11 links with an inlet channel. The second cavity 12 links with an outlet. The intercommunication between the first and second cavities 11, 12 is achieved via the water hole 131. At least one venting hole 111, 121 is arranged on a pipe wall of the first cavity 11 and the second cavity 12, respectively. As shown in the figures, two through holes are symmetrically defined thereon. The sensor 2 similarly adopts the existing techniques. Namely, the sensor 2 is serially composed of a heat-sensing member 21, a supporting member 22, a blocking member 23, and a spring 24. Additionally, the sensor 2 is disposed in the first cavity 11 of the main body 1 and correspondently situated over the water hole 131 at the first necking portion 13. Herein, the sensor 2 sensing the water temperature accordingly decides the open-close state of the water hole 131, thereby controlling the venting state of the channel. The housing 3 is densely sealed for operatively covering on the main body 1. A depressed portion 31 with a larger internal diameter is formed in the middle of the housing 3. Two ends of the housing 3 respectively form second necking portions 32 with a smaller internal diameter. A water cavity is correspondingly formed between the depressed portion 31 and the main body 1. A resuming spring 4 is disposed between the housing 3 and the main body 1. Axially moving the housing 3 in accordance with the main body 1 controls an open-close state of the venting channel between the venting holes 111, 121. Preferably, an anti-scalding sheath 5 could be used to cover the housing 3.

In using, when the water with a temperature higher than the predetermined temperature set in the heat-sensing member 21 of the sensor 2 flows in the main body 1, the heat-sensing member 21 expands after sensing the heat, thereby allowing a telescopic shaft disposed at one end of the heat-sensing member 21 to move forward. As a result, the blocking member 23 is pushed to press the spring 24 for blocking the water hole 131 in the main body 1, so that the channel at the outlet is cut off and the hot water does not flow out. Thence, users are prevented from scalding. In the meantime, the venting hole 121 of the main body 1 is impeded by the second necking portion 32 of the housing 3, so that the venting holes 111, 112 do not communicate with each other. Therefore, the water with a high temperature is blocked in the channel; namely, the hot water does not flow out to scald users. When the water temperature is lower than the predetermined temperature set in the heat-sensing member 21, the initial water with the high temperature blocked in the channel must be swiftly discharged for the sensor 2 to timely sense the temperature and dredge the channel. Accordingly, users impart a force to the housing 3 for pulling the resuming spring 4 to be axially moved downward. Moreover, the venting holes 111, 121 are disposed in accordance with the depressed portion 31 of the housing 3 so as to communicate with the venting channel between the venting holes 111, 121. As a result, the water with a higher temperature that is blocked in the channel is discharged out of the venting hole 111 of the first cavity 11, thence goes into the second cavity 12 through the venting hole 121, and at last is vented from the outlet. The housing 3 is released and resumes to the initial state via the resuming spring 4, and the second necking portion 32 disposed below the housing 3 blocks the venting hole 121. Herein, the discharging of the water is executed under the condition that users realize the happening, so users are not easily scalded. Moreover, the operating time that the sensor 2 senses the water with a regular temperature is accelerated. Thereby, an inner portion of the heat-sensing member 21 shrinks, the telescopic shaft moves backward, the water hole 131 in the main body 1 is opened by means that the spring 24 moves the blocking member 23, and the channels in the first cavity 11 and the second cavity 12 are dredged for achieving a regular discharging state.

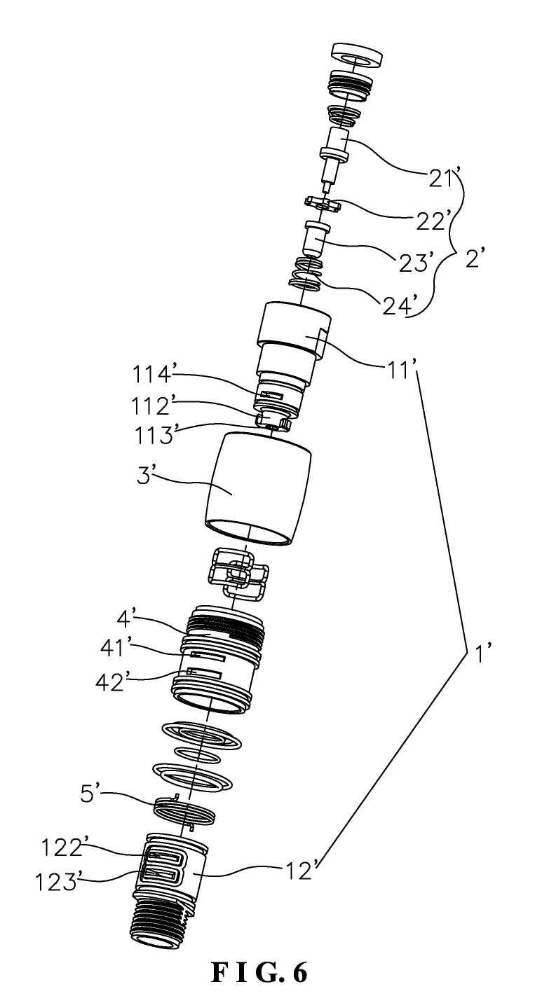

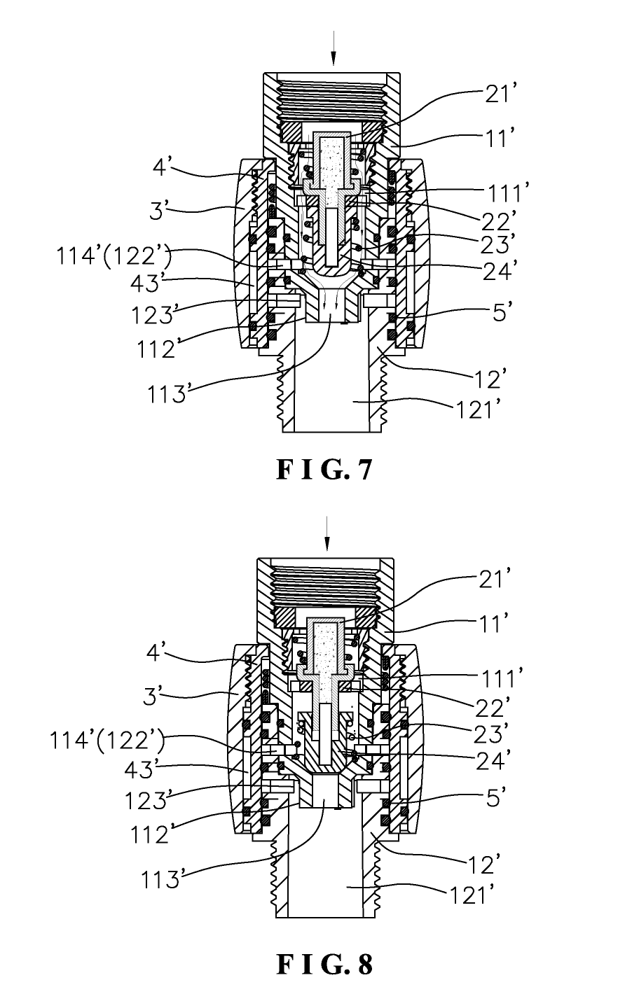

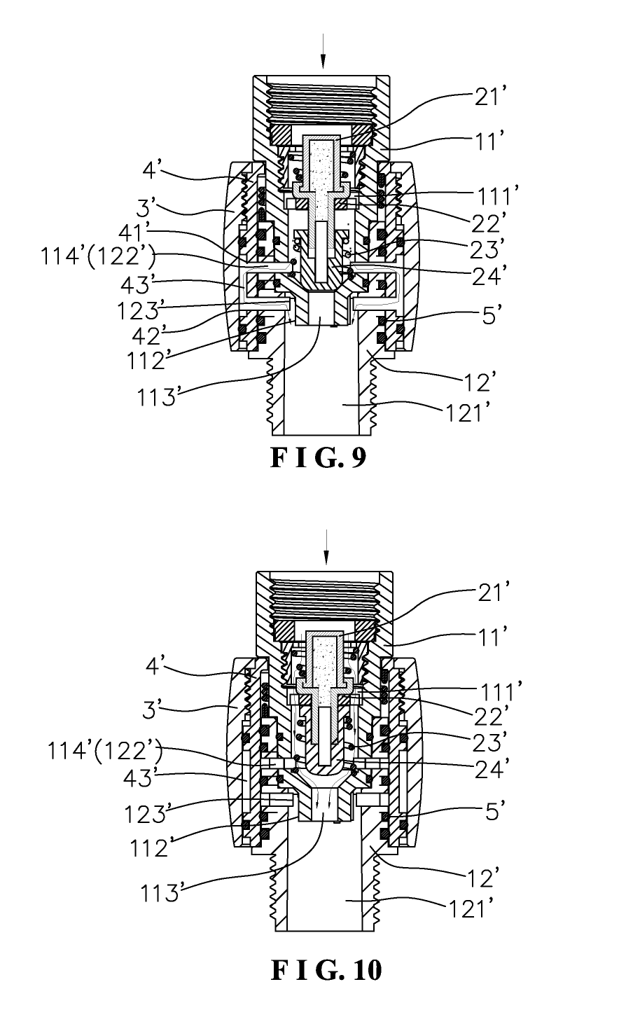

Referring to FIGS. 6 to 10, a second preferred embodiment of the present invention is shown. The present invention substantially comprises a main body 1′, a sensor 2′, and a housing 3′. Differently, the main body 1′ is connectively composed of a chief body 11′ and a connecting portion 12′. Wherein, a first accommodation 111′ communicating with an inlet channel is arranged within the chief body 11′. A first necking portion 112′ with a water hole 113′ is formed at a bottom of the first accommodation 111′. At least one venting hole 114′ is defined on a side wall near the bottom of the first accommodation 111′. A second accommodation 121′ communicating with the outlet is formed within the connecting portion 12′. At least two venting holes 122′, 123′ are defined abreast on a side wall of the second accommodation 121′. Connecting the chief body 11′ with the connecting portion 12′ allows the venting hole 114′ of the first cavity 11′ to be disposed corresponding to the venting hole 122′ of the connecting portion 12′. The composition of the sensor 2′ is as the same as that of the sensor 2 in the previous embodiment. Namely, the sensor 2′, sequentially composed of a heat-sensing member 21′, a supporting member 22′, a blocking member 23′, and a spring 24′, is disposed within the first accommodation 111′ of the chief body 11′ for being correspondently situated over the water hole 113′. The open-close state of the water hole 113′ is controlled by the sensor 2′ sensing the temperature of the water; that is, the water hole 113′ keeps unobstructed when the water temperature is low, but the water hole 113′ is obstructed when the sensor 2′ senses a heating water temperature. The housing 3′ connecting to a casing pipe 4′ is densely rotatable on the main body 1′. Moreover, a torsion spring 5′ is disposed between the casing pipe 4′ and the main body 1′. The casing pipe 4′ defines openings 41′, 42′ whose amount is arranged in accordance with the number of the venting holes 122′, 123′ of the connecting portion 12′. A water cavity 43′ is formed between the housing 3′ and the casing pipe 4′, corresponding to the openings 41′, 42′. In venting, rotating the housing 3′ and the casing pipe 4′ allows the openings 41′, 42′ on the casing pipe 4′ to face the venting holes 122′, 123′ of the connecting portion 12′. Whereby, such arrangement permits the channel to be passable. As to the obstructed water with a high temperature in the channel, it thence goes from the venting hole 114′ of the first accommodation 111′ through the venting hole 122′ of the connecting portion 12′ and through the opening 41′ of the casing pipe 4′ into the water cavity 43′. Then the water further goes from the opening 42′ and the venting hole 123′ into the second accommodation 121′ of the connecting portion 12′, and thereby the water is discharged from the outlet. While loosing the housing 3′ and the casing pipe 4, the openings 41′, 42′ go back to their original positions by means of the torsion spring 5′. As a result, the openings 41′, 42′ of the casing pipe 4′ and the venting holes 122′, 123′ of the second accommodation 121′ stagger and do not intercommunicate. Thereby, the venting channel is cut off.

To sum up, the present invention takes advantage of the disposition of the venting holes on the main body. While axially moving or rotating the casing in correspondence with the main body, the water with a high temperature that is originally obstructed in the channel is able to be swiftly vented. Therefore, the sensor could timely sense the water with a regular temperature and dredges the channel of the outlet, so that the operating time of the sensor is shortened, and it is convenient for users.

I claim:

1. An anti-scalding device with a speedy venting effect comprising a main body, a sensor, and a housing; said main body defining a first cavity and a second cavity communicated with each other; said first cavity linking with an inlet channel; a first necking portion with a water hole being formed at a bottom of said first cavity; said second cavity linking with an outlet; at least one venting hole being arranged on a pipe wall of said first cavity and said second cavity, respectively; said sensor being disposed in said first cavity of said main body corresponding to a top portion of said water hole; said housing being densely sealed for freely covering on said main body; moving said housing allowing to dredge venting channels between said venting holes.

2. The anti-scalding device as claimed in claim 1, wherein, a depressed portion with a larger internal diameter is formed in the middle of said housing; two ends of said housing respectively form second necking portions with a smaller internal diameter; a resuming spring is disposed between said housing and said main body; axially moving said housing in accordance with said main body controls an open-close state of said venting channel between said venting holes.

3. The anti-scalding device as claimed in claim 1, wherein, said main body is composed of a chief body engaging with a connecting portion; a first accommodation is arranged within said chief body for communicating with said inlet channel; a first necking portion with a water hole is formed at said bottom of said first accommodation; at least one venting hole is defined on a side wall of said first accommodation; said second accommodation communicated with said outlet is arranged within said connecting portion; at least two venting holes are defined on a side wall of said second accommodation; connecting said chief body with said connecting portion allows said venting hole of said first accommodation of said chief body to be disposed in accordance with one of said venting holes of said connecting portion.

4. The anti-scalding device as claimed in claim 3, wherein, a casing pipe rotatively and densely disposed on said main body is engaged with said housing; a torsion spring is installed between said casing pipe and said main body; openings, whose amount is arranged in accordance with a number of said venting holes of said connecting portion, are defined on said casing pipe; a water cavity is correspondingly formed between said housing of said opening and said casing pipe; a rotation of said housing and said casing pipe corresponding to said main body controls an open-close state of said venting channel between said venting holes.
